(19) United States
(12) Patent Application Publication
(10) Pub. No.: US 2012/0077386 A1
(43) Pub. Date: Mar. 29, 2012

(54) CABLE ASSEMBLY WITH CONVENIENT ASSEMBLY PROCESS

(75) Inventors: JUN SHU, Shenzhen (CN); ZHONG-LAN LIAO, Shenzhen (CN); JIN-JU WANG, Shenzhen (CN); HUA-YING LIU, Shenzhen (CN)

(73) Assignee: HON HAI PRECISION INDUSTRY CO., LTD., New Taipei (TW)

(21) Appl. No.: 13/244,930

(22) Filed: Sep. 26, 2011

(30) Foreign Application Priority Data
Sep. 29, 2010 (CN) 201020547509.5

(51) Int. Cl. H01R 24/00

(52) U.S. Cl. 439/629

(57) ABSTRACT

A cable assembly comprises: a metal sheet having a body portion defining a receiving hole, a connector received in the receiving hole of the metal sheet and a PCB electrically connected to the conductive terminals and located on the connector. The PCB is fastened on the metal sheet and perpendicular to the body portion of the metal sheet. The connector comprises a set of conductive terminals, an insulative housing enclosing the conductive terminals, a shell made of metal material and located on the front the insulative housing.

### FIELD OF THE INVENTION

The present invention relates to a cable assembly, and more particularly to a cable assembly having a function of EMI prevention.

### DESCRIPTION OF PRIOR ART

CN Pat. No. CN2687897Y, issued on Mar. 23, 2005, disclosed an electrical connector including an insulative housing, a set of conductive terminals received in the insulative housing and a shell. The insulative housing includes a basic portion, a D-shaped mating portion extending forwardly from the basic portion and a plurality of first terminal passages running through the mating portion and the basic portion. The shell includes a main portion enclosing the front surface of the basic portion of the insulative housing and a hollow D-shaped cover extending forwardly from the main portion and enclosing the mating portion of the insulative housing. The electrical connector also includes a circuit board located on the rear of the basic portion having a number of first conductive pads and second conductive pads. A plurality of second terminal passages are formed under the basic portion. The conductive terminals include a number of first terminals and second terminals. Each of the first terminals has a touching portion receiving in the first terminal passage and a connecting leg extending out of the first passage and connected to the first conductive pad of the circuit board. Each of the second terminals includes a retaining portion received in the second terminal passage, a tail portion extending out of the second terminal passage and a connecting portion connected to the second conductive pad of the circuit board. The second terminals respectively connecting to the second conductive pads electrically are connected to the first conductive pads for connecting electrically to the first terminals. As the circuit board located on the rear of the basic portion and an inner space accommodating the circuit board being small, the operation is very inconvenient, it may be occur status that the conductive terminals may be not soldered on the right conductive pads when the conductive terminals need to soldered on the conductive pads needed.

As discussed above, an improved cable assembly overcoming the shortages of existing technology is needed.

### SUMMARY OF THE INVENTION

Accordingly, an object of the present invention is to provide a cable assembly with convenient assembly process.

In order to achieve the above-mentioned objects, A cable assembly comprises: a metal sheet having a body portion defining a receiving hole, a connector received in the receiving hole of the metal sheet and a PCB electrically connected to the conductive terminals and located on the connector. The PCB is fastened on the metal sheet and perpendicular to the body portion of the metal sheet. The connector comprises a set of conductive terminals, an insulative housing enclosing the conductive terminals, a shell made of metal material and located on the front the insulative housing.

Other objects, features and advantages of the invention will be apparent from the following detailed description taken in connection with the accompanying drawings.

### BRIEF DESCRIPTION OF THE DRAWINGS

FIG. 1 is a perspective view of a cable assembly in accordance with the present invention;

FIG. 2 is a view similar to FIG. 1, but from another aspect;

FIG. 3 is an exploded, perspective view of the cable assembly shown in FIG. 1; and

FIG. 4 is a view similar to FIG. 3, but from another aspect.

### DETAILED DESCRIPTION OF PREFERRED EMBODIMENTS

Reference will now be made to the drawing figures to describe the present invention in detail.

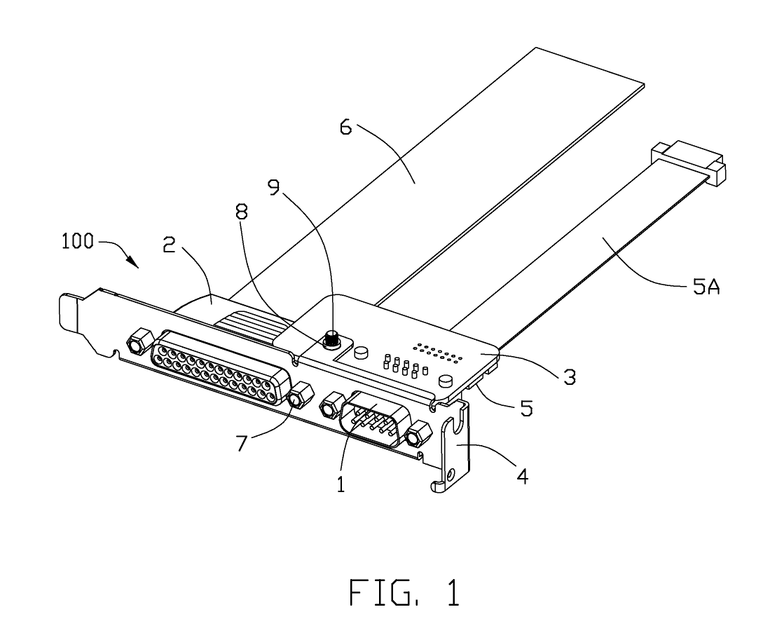

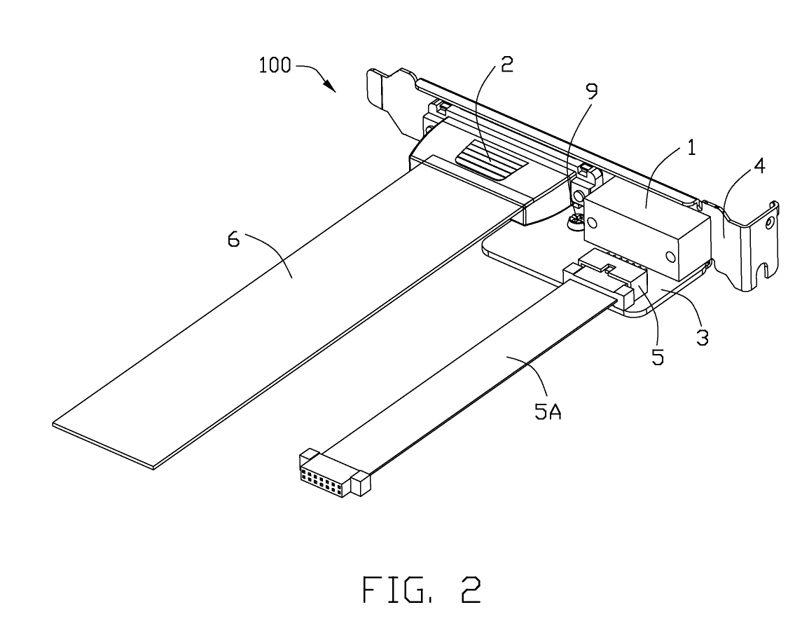

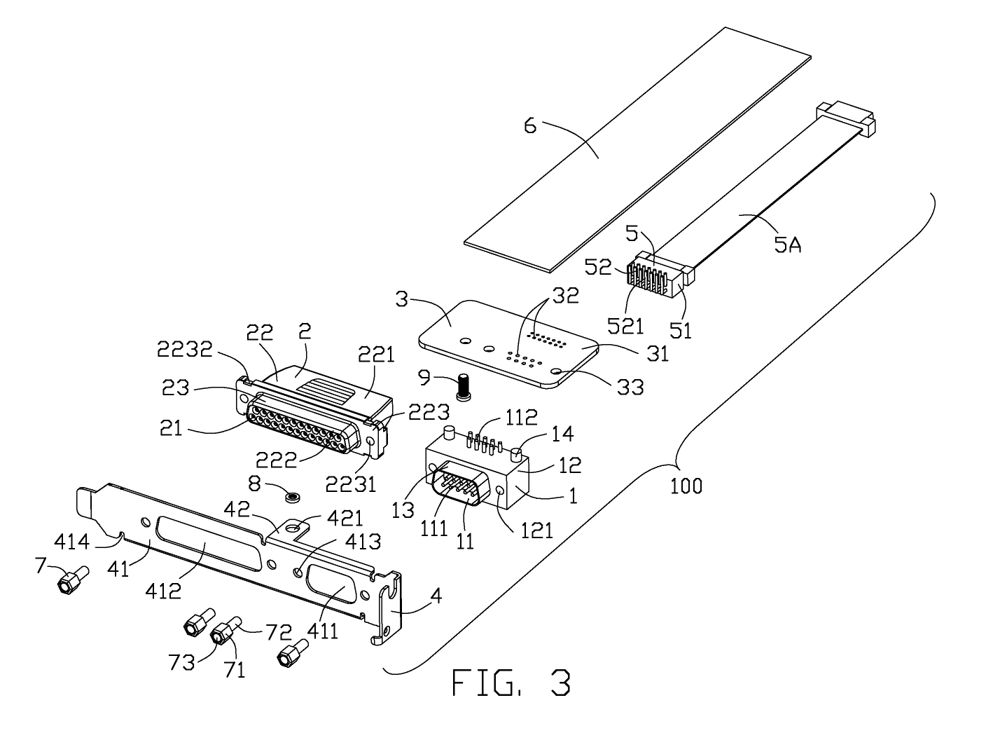

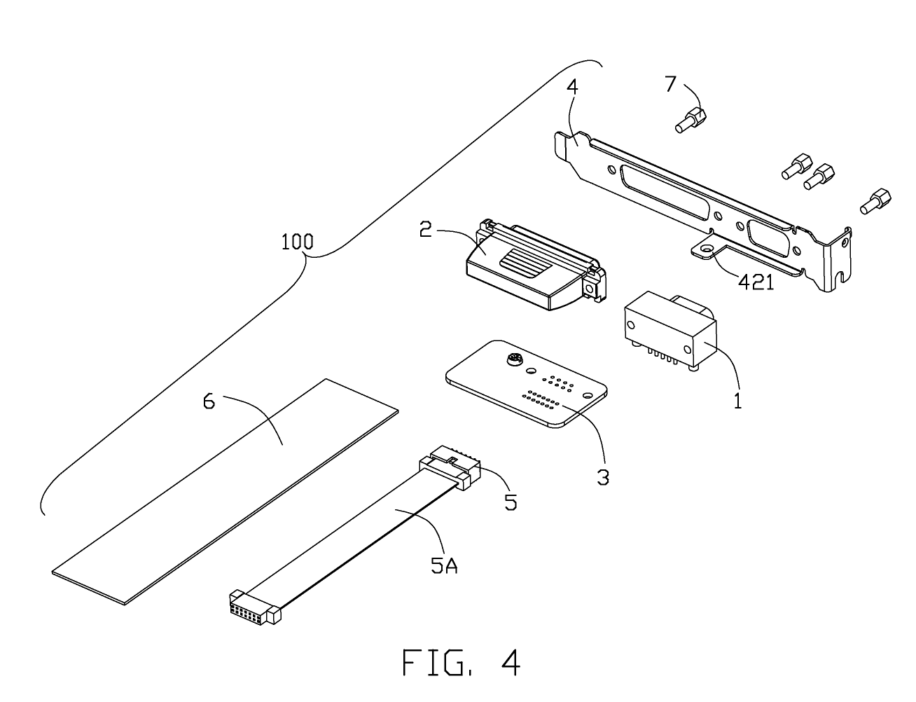

Referring to FIGS. 1 to 4, a cable assembly 100 in accordance with the present invention comprises a first connector 1, a second connector 2, a PCB (printed circuit board) 3 connected to the first connector 1, a metal sheet 4 assembled on the front of the first connector 1 and the second connector 2, an adapter connector 5 connected electrically to the PCB 3, a flat cable 6 connected to the second connector 2, a number of locking members 7, a fastening member 9 and a nut 8 corresponded to the fastening member 9.

The first connector 1 comprises a set of first terminals 11, a first insulative housing 12 enclosing the first terminals 11, a D-shaped first shell 13 made of metal material and located on a front surface of the first insulative housing 12 and a pair of columns 14 located on an upper surface of the first insulative housing 12. Each of the first terminals is of L-shaped configuration and includes a retaining portion (not shown) enclosed in the first insulative housing 12, a mating portion 111 extending forwardly from the retaining portion and exposed out of the front surface of the insulative housing 12 and a soldering portion 112 extending upwardly from the retaining portion and exposed out of the upper surface of the insulative housing 13. The mating portions 111 are surrounded by the first shell 13. The columns 14 are respectively located at two sides of the soldering portions 112 of the first terminals 11. The insulative housing 12 also defines a pair of mounting holes 121 recessed from the front surface thereof and located at two sides of the first shell 13.

The second connector 2 comprises a set of second terminals 21, a second insulative housing 22 enclosing the second terminals 21 and a second shell 23 enclosing the second insulative housing 22. The second insulative housing 22 comprises a basic portion 221 located on the rear thereof, a D-shaped engaging portion 222 extending forwardly from the basic portion 221 and a rectangular flange 223 located between the basic portion 221 and the engaging portion 222. The flange 223 has an assembling hole 2231 passing through the front and rear thereof and two pair of cuts 2232 located on the lateral sides thereof. The second shell 23 is made of metal material and encloses the engaging portion 222 of the second insulative housing 22.

The PCB 3 comprises a substrate 31, a number of conductive pads (no shown) located on an upper surface of the substrate 31, a number of terminal holes 32 running through the upper and lower surface of the substrate 31 and three through holes 33 running through the upper and lower surface of the substrate 31 and located on two sides of the terminal holes 32. Two of the through holes 33 correspond to the columns 14 of the first connector 1.

The metal sheet or bracket 4 is made from stamping and comprises a L-shaped body portion 41 and a mounting portion 42 extending rearwardly from a lateral side of the body portion 41. The body portion 41 comprises a first receiving hole 411 receiving the first shell 13, a second receiving hole 412 receiving the second shell 23, two pair of first installing holes 413 respectively receiving locking members 7 and corresponding to the mounting holes 12 of the first insulative housing 12 and the assembling holes 2231 of the second insulative housing 22, and a number of cuts 414 running through the front and rear surface thereof and located on two lateral sides thereof. The mounting portion 42 is of L-shaped configuration and defines a second installing hole 421 corresponding to one of the through holes 33.

The adapter connector 5 comprises a third insulative housing 51 and a set of transferring terminals 52 enclosed in the third insulative housing 51. The transferring terminal 52 is of L-shape configuration and comprises a retaining portion (not shown) receiving in the third insulative housing 51, a soldering portion 521 located on a front surface of the retaining portion (not shown) and perpendicular to the retaining portion (not shown) and a mating portion (not shown) extending rearwardly from the retaining portion (not shown).

The locking member 7 comprises a hexagonal nut 71, a cylindrical screw 72 extending rearwardly from the nut 71 and a threaded hole 73 recessing rearwardly from the front surface of the nut 71.

The cable assembly 100 also comprises a third connector assembly 5A connected to the adapter connector 5. The third connector assembly 5A includes a cable (not labeled) and two connector (not labeled) located on two sides of the cable (not labeled).

In assembly, the solder portions 112 of the first terminals 11 of the first connector 1 are received in the terminal holes 32 by passing through the PCB 3 from the lower surface to the upper surface of the PCB 3. The transferring terminals 52 of the adapter connector 5 are received in the terminal holes 32 by passing through the PCB 3 from the lower surface to the upper surface of the PCB 3. The columns 14 on the first insulative housing 12 respectively receiving in the through holes 33 of the PCB 3, which both are interference to each other. Added some tin on the terminal holes 32 of the PCB, the soldering portion 112, 521 are respectively connected electrically to the conductive pads of the PCB 3. The first shell 13 of the first connector 1 is nm through the first receiving hole 411 of the metal sheet 4 and the second shell 23 of the second connector 2 is run through the second receiving holes 412 of the metal sheet 4. The rear surface of the body portion 41 of the metal sheet 4 is attached to both the front surface of the first insulative housing 12 and the front surface of the flange 223 of the second insulative housing 22. The first installing holes 413 of the body portion 41 is aligned to the mounting holes 121 of the first insulative housing 11 and the assembling hole 2231 of the flange 223. Received in the first installing holes 413, the mounting holes 121, the assembling hole 2231, the screws 72 of the locking members 7 are locked on the metal sheet 4, the first connector 1 and the second connector 2. The metal sheet 4 is connected to the PCB 3 located under the mounting portion 41 by the fastening member 9 running through the second installing holes 421 and the through hole 33. The nut 8 is locked on the fastening member 9 for fastening the metal sheet 4 is connected to the PCB 3. The cable 6 is electrically connected to the second terminals of the second connector 2.

In other embodiments, the assembling technical solution of PCB 3 can be implemented by the metal sheet 4 being assembled on one connector (the first connector 1) only.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A cable assembly, comprising:
a metal sheet having a body portion defining a receiving hole;
a connector received in the receiving hole of the metal sheet, and comprising:
a set of conductive terminals;
an insulative housing enclosing the conductive terminals;
a shell made of metal material and located on a front surface of the insulative housing, and
a PCB electrically connected to the conductive terminals and located on a surface of the connector; wherein
the PCB is fastened on the metal sheet and perpendicular to the body portion of the metal sheet.

2. The cable assembly as recited in claim 1, wherein the PCB defines a number of through holes running through the upper and lower surface thereof.

3. The cable assembly as recited in claim 2, wherein the metal sheet also defines a mounting portion extending rearwardly from a lateral side of the body portion and defining an installing hole corresponding to one of the through holes.

4. The cable assembly as recited in claim 3, wherein the able assembly also includes a fastening member running through the through hole and the installing hole for retaining the PCB and the metal sheet.

5. The cable assembly as recited in claim 4, wherein the PCB is assembled on a surface of the insulative housing.

6. The cable assembly as recited in claim 5, wherein a pair of columns are disposed on the surface of the insulative housing and received in two through holes of the PCB.

7. The cable assembly as recited in claim 1, wherein the conductive terminals run through the PCB from a surface to another surface of the PCB.

8. The cable assembly as recited in claim 7, wherein the cable assembly also comprises an adapter connector having a set of transferring terminals.

9. The cable assembly as recited in claim 8, wherein the transferring terminals are soldered on the PCB.

10. The cable assembly as recited in claim 9, wherein the transferring terminals are through the PCB from a surface to another surface of the PCB.

11. A cable assembly, comprising:
a first connector comprising:
a set of first conductive terminals; and
a first insulative housing enclosing the first conductive terminals;
a second connector comprising:
a set of second conductive terminals;
a second insulative housing enclosing the first conductive terminals; and
a metal shell enclosing the second insulative housing;
a metal sheet assembled on the front of the first and second connector; and
a PCB located on a surface of the first connector and fastening on the metal sheet.

12. The cable assembly as recited in claim 11, wherein the cable assembly also includes a fastening member and a nut matching the fastening member.

13. The cable assembly as recited in claim 12, wherein the PCB has a through hole running though the upper and lower surface thereof.

14. The cable assembly as recited in claim 13, wherein the metal sheet also comprises an installing hole corresponding to the through hole.

15. The cable assembly as recited in claim 14, wherein the fastening member is received in the through hole and the installing hole and matching the nut for retaining the PCB and the metal sheet.

16. A cable connector assembly comprising:
a metallic bracket defining at least on through hole extending through opposite front and rear surfaces in a front-to-back direction;
a printed circuit board directly fastened to the bracket behind the rear surface and extending in the front-to-back direction with opposite front and rear regions in the front-to-back direction and opposite first and second surfaces in a vertical direction perpendicular to said front-to-back direction;
a first electrical connector assembled to the rear surface of the bracket and on the first surface of the front region of the printed circuit board with a first mating port extending forwardly through the at least one through hole for connection with a first exterior part; and
a first cable mechanically and electrically assembled to the rear region of the printed circuit board for connection with a first interior part.

17. The cable connector assembly as claimed in claim 16, wherein the bracket defines a supporting tab assembled on the second surface of the front region of the printed circuit board.

18. The cable connector assembly as claimed in claim 16, wherein the bracket further defines another through hole spaced from the through hole in a transverse direction perpendicular to both the front-to-back direction and the vertical direction.

19. The cable connector assembly as claimed in claim 18, further including a second connector assembled to the rear surface of the bracket with a second mating port extending forwardly through said another through hole for connection to a second exterior part.

20. The cable connector assembly as claimed in claim 19, further including a second cable directly mechanically and electrically connected to a rear side of the second connector.
